(19) United States
(12) Patent Application Publication
(10) Pub. No.: US 2012/0249012 A1
(43) Pub. Date: Oct. 4, 2012

(54) METHOD AND SYSTEM FOR SUPPLYING MULTIPLE LED DRIVERS USING THE SAME TRAIC DIMMER

(75) Inventor: Abel Xu, Shenzhen (CN)

(73) Assignee: GRE ALPHA ELECTRONICS LTD., Hong Kong (HK)

(21) Appl. No.: 13/075,200

(22) Filed: Mar. 30, 2011

(51) Int. Cl. H05B 37/02; H02H 3/22

(52) U.S. Cl. 315/291; 361/111

(57) ABSTRACT

An RCD transient absorption circuit, having a first port and a second port, the RCD transient absorption circuit comprising a first resistor, a capacitor and a diode, wherein: the first resistor is connected in parallel to the capacitor, and resultant parallel connection of which is connected in series to a diode; one end of the resultant parallel connection of the first resistor and the capacitor is connected to a cathode of the diode; another end of resultant parallel connection is the first port of the RCD transient absorption circuit; and the second port of the RCD transient absorption circuit is an anode of the diode; the RCD transient absorption circuit further comprises a power-trimming device connected in parallel to the first resistor and the capacitor.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CLAIM FOR FOREIGN PRIORITY

This application claims priority under 35 U.S.C. §119 to the China patent application 201110040964.5, filed Feb. 18, 2011, the disclosure of which is incorporated herein by reference.

### FIELD OF THE INVENTION

The present invention relates generally to light emitting diode (LED) drivers. More specifically, the present invention relates to a dimmable lighting LED driver system and a method of dimming thereof. Still more specifically, the present invention is related to the use of the same triode for alternating current (TRIAC) dimmer to control the dimming of a plurality of LED drivers.

### BACKGROUND

Traditionally, incandescent and fluorescent lights have been the primary source of artificial illumination. However, significant advances in the light emitting diode (LED) technology have made the light output of LEDs not only for indicator applications but also sufficient for general illumination.

LEDs are a type of semiconductor device requiring direct current (DC) electricity input source for operation. Conventional LED lighting unit comprises a LED driver power supply, a dimming module, a dimming controller panel, and arrays of LEDs. The LED driver power supply takes an external electricity power input source and convert to a constant direct current output, feeding the dimming module and in turn the LEDs. For land and building use, the external power source is usually an alternative current electricity power source. In such conventional LED lighting unit, one limitation is that the choice of LED driver power supply used must be carefully matched with the capacity of the LEDs, as the maximum current driving the LEDs is fixed by the LED driver power supply based on its type and capacity.

One common type of dimming module is the triode for alternating current (TRIAC) dimmer. Traditionally, one TRIAC dimmer is paired with one LED driver.

FIG. 1 depicts the use of a TRIAC dimmer to perform the light-dimming operation via the control of input power to a plurality of LED drivers, each of which includes a flyback switching-mode power supply (not shown in the figure). In the system, the power inputs of the plurality of LED drivers are connected in parallel to form a single source of power input, and this single source of power input is in turn connected in series to the TRIAC dimmer. The function of the TRIAC dimmer is to modulate the conduction angle of the AC input voltage, making the LED drivers connected thereafter change the output current levels accordingly. Dimming can be achieved as the output current is used to drive the LED in a lamp and the current level determines the brightness of the LED. One end of the TRIAC dimmer is connected to the Live (L) of the AC input. The power supply common to all LED drivers is coupled to the other end of the TRIAC dimmer and the Neutral (N) of the AC input. Although dimming can be achieved by the arrangement shown in FIG. 1, a major problem is that the start-up times for LEDs controlled by different LED drivers are not the same. The start-up time is the time that the LED starts to give out its light.

As the conduction angle of the TRIAC dimmer changes, the voltage of the power supply common to all LED drivers also changes. When the voltage increases to the working voltage of the LED driver integrated circuit (IC) in a LED driver, the LED driver begins to operate. At that time, the output voltage levels of all the LED drivers do not reach the threshold voltage required for LEDs to light up. The LEDs do not glow. As the conduction angle of the TRIAC dimmer increases, the power input to LED drivers also increases. When the output voltage of a LED driver reaches the threshold voltage, the LED begins to glow. At that time, the LED driver is still working in an open-loop condition, and the feedback control circuit does not work. When the conduction angle of the TRIAC dimmer increases so that the output voltage level of the LED driver also increases, the output current reaches the full-load current condition required for the LED. Afterwards, the LED driver operates in a closed-loop mode. The control circuit comes into operation. It is possible to adjust the output current based on the control circuit. The luminance of the LED reaches the maximum value. At that time, increasing the conduction angle of the TRIAC dimmer does not change the luminance of the LED. However, in the presence of multiple LED drivers using the same TRIAC dimmer as shown in FIG. 1, and when these LED drivers are working in the open-loop mode, it is noticed that variation in component parameters (namely, difference between the actual value and the nominal value of a component) for the LED drivers leads to different power dissipation levels in the circuits. It follows that the actual power outputs of the LED drivers are not the same and the output current levels are also not the same. This variation of output current levels leads to the visual effect that some of LEDs glow up first and some of LEDs glow up later. That is, the LEDs driven by different LED drivers do not start to glow at the same time. In addition, the luminance levels of the LEDs are not the same.

FIG. 2 is a transient absorption circuit installed in a LED driver, according to the state of the art. This circuit comprises a resistor, a capacitor, and a diode, the circuit being referred to as an RCD transient absorption circuit. In the RCD transient absorption circuit, the resistor R1 201 and the capacitor C1 204 are connected in parallel, followed by connecting the resultant unit to a diode D1 202 in series. One winding of the transformer T1 205 is connected in parallel to the unit formed by the three aforementioned components, and in series to the switcher Q1 203. The other winding of the transformer T1 205 is connected to the output section of the LED driver (not shown in the figure). The RCD transient absorption circuit is connected with the full-wave bridge rectifier (not shown in the figure). The function of the RCD transient absorption circuit is illustrated as follows. When the flyback switching mode power supply is operating, and when the switcher Q1 203 is turning off, the inductance of the transformer can lead to a high peak voltage. The RCD transient absorption circuit is used to absorb this voltage peak in order to protect the switcher Q1 203 from being punched through by the high voltage. Note that if the switcher Q1 203 is punched through, the whole LED driver cannot properly work. In the start-up phase and in the low-load condition, the RCD transient absorption circuit is the main source of power loss. Since the RCD transient absorption circuit in the state of the art does not incorporate a function of controlling the power loss, it follows that the LEDs powered by different LED drivers cannot achieve uniformity in the start-up time and in luminance.

### SUMMARY

To address the aforementioned problem, the presently claimed invention provides a dimmable LED driver system that incorporates an RCD transient absorption circuit, and a method of light dimming. The presently claimed invention overcome the problem of start-up time misalignment in the presence of multiple LED drivers, where this misalignment causes the problem of LEDs not glowing up at the same time and not having the same luminance.

The RCD transient absorption circuit comprises a first resistor, a capacitor and a diode. In this circuit, the first resistor is connected in parallel to the capacitor followed by connecting the resultant unit in series with the diode, wherein: one end of the unit formed by connecting in parallel the first resistor and the capacitor is connected to the cathode of the diode; another end of this unit is the first port of the RCD transient absorption circuit; and the anode of the diode is the second port of this RCD transient absorption circuit. The RCD transient absorption circuit further comprises a power-trimming device, which is connected in parallel to the first resistor and the capacitor.

The presently claimed invention also provides a dimmable LED driver system that allows the dimming function to be controlled by a dimmer therein. The dimmable LED driver system comprises a dimmer and at least one LED driver. The LED driver comprises: an AC-to-DC converter that matches the characteristics of the dimmer; a transformer for storing energy and for changing the voltage level; an output section for supplying power to LED(s) for the lighting purpose; and a pulse-width-modulation (PWM) controller and a switcher, both of which are used for control of the output power. In addition, the aforementioned LED driver uses the RCD transient absorption circuit disclosed in the present invention, where the first and the second ports of the RCD transient absorption circuit are connected to the two ports of the primary winding of the transformer, and the aforementioned first port is connected to the output of the AC-to-DC converter.

Furthermore, the presently claimed invention also provides a method that employs a dimmer to perform the dimming function on LED drivers. This method comprises: installing the RCD transient absorption circuit disclosed in the present invention into each of the plurality of LED drivers; choosing one LED driver as the reference driver, and setting the conduction angle of the dimmer such that the reference driver delivers an output current that is 1% within the full-load current; measuring the output current levels of LED drivers other than the reference driver; and adjusting the power-trimming device of the RCD transient absorption circuit in each of the LED drivers such that the output current is the same as that of the reference driver.

The advantage of this invention is summarized as follows. Using the dimmable LED driver system that employs the disclosed RCD transient absorption circuit enables one to adjust the start-up output power level. It follows that the output current levels delivered from multiple LED drivers can be made the same, thus enabling different LEDs to glow up at the same time.

### BRIEF DESCRIPTION OF THE DRAWINGS

Embodiments of the invention are described in more detail hereinafter with reference to the drawings, in which

FIG. 1 is a schematic diagram showing the use of a TRIAC dimmer to perform the dimming operation on a plurality of LED drivers;

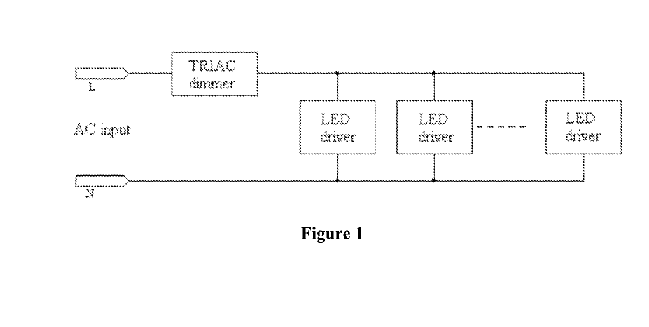

FIG. 2 shows a transient absorption circuit used in a LED driver according to the state of the art;

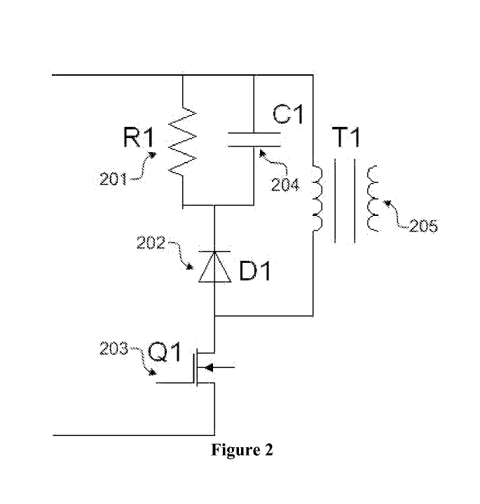

FIG. 3 shows a RCD transient absorption circuit according to the first embodiment of the presently claimed invention;

FIG. 4 shows a RCD transient absorption circuit according to the second embodiment of the presently claimed invention; and

FIG. 5 is a circuit diagram for a TRIAC dimmer and a LED driver realized according to the second embodiment of the presently claimed invention, the LED driver serving the purpose of an example for illustration.

### DETAILED DESCRIPTION

In the following description, method and system for supplying multiple LED drivers using the same TRAIC dimmer and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the presence of variation of component parameter values, the presently claimed invention operates by adjusting the power loss to control the output power level, and overcomes the problem of unsynchronized start-up time and unequal luminance levels caused by different power losses among different LED drivers. The presently claimed invention achieves the desired result that the LEDs give out their light synchronously at the start-up time and produce the light at the same luminance level. In a flyback switching mode power supply, the components having higher losses are the MOS switcher, transformer, rectifier diode, and RCD transient absorption circuit. Therefore, the main approach of the presently claimed invention is to modify the RCD transient absorption circuit in order to control the power loss.

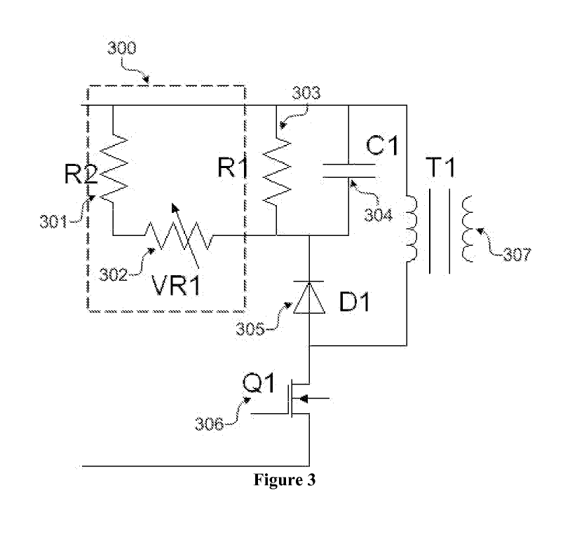

Referring to the circuit diagram of the RCD transient absorption circuit as shown in FIG. 3. In this circuit, a power-trimming device PTD1 300, resistor R1 303 and capacitor C1 304 are connected in parallel, and the resultant combined unit is serially connected to cathode of diode D1 305. The unit formed by the aforesaid four components: power-trimming device PTD1 300, resistor R1 303, capacitor C1 304, and the diode D1 305, is connected in parallel to a winding of transformer T1 307. That is, one port of the winding of transformer T1 307 is connected to power-trimming device PTD1 300, resistor R1 303 and capacitor C1 304; and the other port is connected to the anode of diode D1 305. The other winding of transformer T1 307 is connected to the output section of the LED driver (not shown in the figure). This RCD transient absorption circuit is connected to a full-wave bridge rectifier (not shown), serving the purpose of AC-to-DC conversion. In the preferred implementation of the first embodiment, power-trimming device PTD1 300 is the serially connected cascade of variable resistor VR1 302 and protection resistor R2 301. This power-trimming device PTD1 is connected in parallel to resistor R1 303, and capacitor C1 304. The function of the RCD transient absorption circuit is to absorb the voltage peak occurred at switcher Q1 306 in order to prevent it from being punched through. The resistance range of variable resistor VR1 302 is normally from a few 10 k ohms to some 100 k ohms, determined according to: the inductance value of transformer T1 307; the values of resistor R1 303, capacitor C1 304, and diode D1 305; and the variation of the power input to the LED driver. The addition of protection resistor R2 301 in the embodiment is to prevent any mistaken operation on variable resistor VR1 302. Even if variable resistor VR1 302 is mistakenly adjusted to zero ohm, neither variable resistor VR1 302 nor the rest of the circuit will be damaged. Normally, protection resistor R2 301 is in the range of a few 10 k ohms. Note that resistors R1 303, capacitor C1 304, and diode D1 305 are commonly used components in existing transient absorption circuits. Switcher Q1 306 can be any component that can achieve its purpose. Switcher Q1 306 can be a MOSFET or a triode. Taken an re-channel MOSFET as an exemplary implementation of switcher Q1 306, the drain is connected to the anode of diode D1 305, the source is connected to a full-wave bridge rectifier (not shown), and the gate is connected to a PWM controller (not shown). The PWM controller controls the output section of the LED driver through the feedback network.

Despite the advantage of adding protection resistor R2 301 into the power trimming device PTD1 300, it is optional to remove this resistor for cost advantage. One embodiment of this invention is therefore a power trimming device comprising a variable resistor only.

In a system with a plurality of LED drivers, one of them is chosen as a reference driver. When a driver has an output current greater than that of the reference driver during the start-up stage, the value of variable resistor VR1 302 can be reduced; otherwise, its value can be increased. The function of variable resistor VR1 302 is to change the power loss of the circuit in order to change the output power at the start-up time. It is based on the following formula:

Pᵢₙ=Pₗₒₛₛ+Pₒᵤₜ, where Pᵢₙ is the input power, Pₗₒₛₛ is the power loss, and Pₒᵤₜ is the output power.

Pᵢₙ is a normally a constant. By adjusting the power loss in variable resistor VR1 302, one can reduce Pₗₒₛₛ in order to ensure that the difference between the input power and the output power is kept small. The RCD transient absorption circuit detailed in this embodiment is particularly suitable for the following situations: when the output power is small, for example, when the output power is less than 15 W; or when the inductance value of transformer T1 307 is small, for example, if it is less than 15 μH.

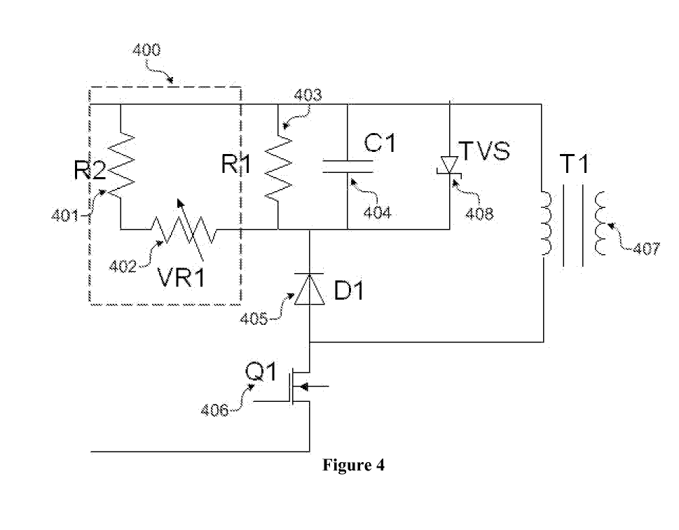

Referring to the diagram of the RCD transient absorption circuit as shown in FIG. 4. Apart from power-trimming device PTD1 400, resistor R1 403 and capacitor C1 404 as illustrated in FIG. 3, one can insert a transient voltage suppressor (TVS), which is connected in parallel to power-trimming device PTD1 400, resistor R1 403 and capacitor C1 404 with the additional requirement that the cathode of the TVS 408 is also connected to cathode of the diode D1 405. In the preferred implementation of the second embodiment, the TVS 408 is connected in parallel to: the cascade of variable resistor VR1 402 in series with protection resistor R2 401; resistor R1 403; and capacitor C1 404. The working principle of this RCD transient absorption circuit is similar to that of the first embodiment. The parameters of the additional TVS 408 are determined according to the inductance and the clamped voltage. When a high-energy impulse appears, the function of the TVS 408 is to reduce its conductance to a low value in order to allow a larger current to pass and at the same time clamp the voltage to a predetermined level. When under the no-load or light-load condition, the TVS 408 does not work. In this condition, diode D1 405, resistor R1 403, protection resistor R2 401, variable resistor VR1 402 and capacitor C1 404 clamp and adjust the power loss. In the condition of heavy load or full load, the TVS 408 functions and ensures that the peak voltage does not damage switcher Q1 406. The second embodiment for the RCD transient absorption circuit is especially suitable for use in the situation that the output power is large or that the inductance value of transformer T1 407 is large. In this situation, a capacitor with a small capacitance value can be used for capacitor C1 404 in order to reduce the loss.

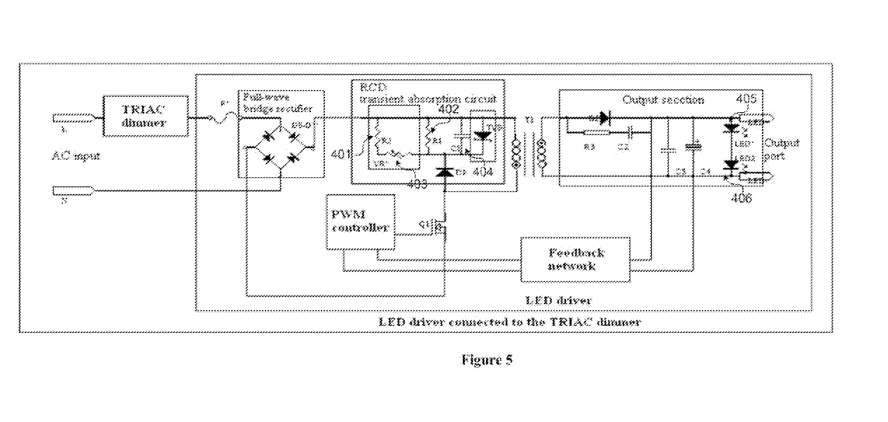

FIG. 5 is a circuit diagram showing a TRIAC dimmer and an example LED driver realized according to the second embodiment of the presently claimed invention. The AC input is connected to the AC-to-DC converter via a TRIAC dimmer. A preferred realization of the AC-to-DC converter is a full-wave bridge rectifier. The electric power from the output of the AC-to-DC converter is fed to the primary winding of the transformer. The secondary winding of the transformer is connected to the output section. The end of the output section is connected to a group of series-connected LEDs. Note that the output section performs rectification and filtering on the power obtained from the transformer. It is also noticed that the RCD transient absorption circuit is connected to the primary winding of the transformer. In the circuit, the PWM controller is used to control the switcher, and it can be realized by any IC under the relevant category, for example: SSL2101 and SSL2102. The PWM controller is connected to the output section via a feedback network, wherein the feedback network is a feedback loop for ensuring the stability of the circuit. During start-up, the current passing through the LEDs is small. After start-up, the voltage and the current supplied to the LEDs can be modified by means of changing the conduction angle of the TRIAC dimmer, so that the luminance level of the LEDs can be modified.

In the aforementioned two embodiments related to the RCD transient absorption circuit, the tolerance levels of components are required to be at least better than: 1% for resistor R1 402 and protection resistor R2 401; 10% for variable resistor VR1 403, and 10% for capacitor C1 404. The value of resistor R1 402 is usually greater than that of protection resistor R2 401, a larger value of R1 402 being able to ensure proper working of the circuit. During start-up and under the same input voltage level, the current taken up by a LED driver realized by existing technology varies between less than 1 mA to 6 mA. (This range is different for a different output current level, but the commonality is that the range is wide.) For the LED drivers with the improved RCD transient absorption circuit disclosed herein, the output currents during start-up, viz., the current passing through LED1 405 and LED2 406, maintain at a rather constant value within the aforementioned range. Since the variation of the current level is relatively small, it can maintain the output current levels at Io*1%±20% where Io is the full-load output current. For example, when the output current is 350 mA, the output current at start-up can be maintained within a range of 2.8-4.2 mA. The stability of output current levels ensures that the LEDs start to glow at the same time and have the same luminance level.

In addition, the presently claimed invention provides a method to employ a TRIAC dimmer to control LED drivers. Under the same condition of supply voltage, adjust the conduction angle of the TRIAC dimmer such that the output current of a reference LED driver is 1% of the full-load current. Fixing this conduction angle, one can adjust variable resistor VR1 403 of another LED driver in order that the output current provided to the LED is the same as that of the reference driver.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalences.

What is claimed is:

1. An RCD transient absorption circuit, having a first port and a second port, the RCD transient absorption circuit comprising a first resistor, a capacitor and a diode, wherein:
the first resistor is connected in parallel to the capacitor, and resultant parallel connection of which is connected in series to a diode;
one end of the resultant parallel connection of the first resistor and the capacitor is connected to a cathode of the diode;
another end of resultant parallel connection is the first port of the RCD transient absorption circuit; and
the second port of the RCD transient absorption circuit is an anode of the diode;
the RCD transient absorption circuit further comprises a power-trimming device connected in parallel to the first resistor and the capacitor.

2. The RCD transient absorption circuit of claim 1, wherein the power-trimming device is a variable resistor.

3. The RCD transient absorption circuit of claim 1, wherein the power-trimming device is formed by a second resistor and a variable resistor connected in series.

4. The RCD transient absorption circuit of claim 2, wherein the variable resistor has a resistance range from a few 10 k ohms to a few 100 k ohms.

5. The RCD transient absorption circuit of claim 3, wherein the second resistor has a resistance value of a few 10 k ohms in order to protect the variable resistor from being mistakenly set to zero ohm.

6. The RCD transient absorption circuit of claim 1, further comprising a TVS connected in parallel to the power-trimming device, wherein the cathode of the TVS is also connected to the cathode of the diode.

7. A dimmable LED driver system comprising a dimmer and at least one LED driver, each LED driver comprising:
an AC-to-DC converter that matches the characteristics of the dimmer;
a transformer for storing energy and for changing the voltage level;
an output section for supplying power to LED(s) for lighting; and
a PWM controller and a switcher, both of which are used for control of the output power;
wherein the dimmable LED driver system is controlled by the dimmer; the at least one LED driver uses an RCD transient absorption circuit; a first port and a second port of the RCD transient absorption circuit connect to a first end and a second end of the primary winding of the transformer respectively; and the first port of the RCD transient absorption circuit connects to an output of the AC-to-DC converter.

8. The dimmable LED driver system of claim 7, wherein the dimmer is a TRIAC dimmer.

9. The dimmable LED driver system of claim 8, wherein the TRIAC dimmer is series connected to the at least one LED driver.

10. A method that employs a dimmer to perform the dimming function on a plurality of LED drivers, the method comprising the steps of:
installing an RCD transient absorption circuit into each of the plurality of LED drivers, wherein the RCD transient absorption circuit includes a power-trimming device;
choosing one LED driver as a reference driver;
setting the dimmer to a conduction angle;
adjusting the conduction angle such that the reference driver delivers an output current that is 1% within full-load current;
measuring output current level of each of the plurality of LED drivers other than the reference driver; and
adjusting the power-trimming device of the RCD transient absorption circuit in each of the LED drivers such that the output current is the same as that of the reference driver.
